(19) United States
(12) Patent Application Publication
(10) Pub. No.: US 2025/0051574 A1
(43) Pub. Date: Feb. 13, 2025

(54) ASPHALT COMPOSITIONS INCLUDING ASPHALTENE AND EPOXY-FUNCTIONALIZED ETHYLENE COPOLYMER

(71) Applicant: Dow Global Technologies LLC, Midland, MI (US)

(72) Inventors: Fabricio Arteaga Larios, Sugar Land, TX (US); Cristina Serrat, Sugar Land, TX (US); Sean P. Doughty, Richwood, TX (US)

(73) Assignee: Dow Global Technologies LLC, Midland, MI (US)

(21) Appl. No.: 18/718,583

(22) PCT Filed: Dec. 20, 2022
(86) PCT No.: PCT/US2022/053571

§ 371 Date: Jun. 11, 2024

Related U.S. Application Data
(60) Provisional application No. 63/293,126, filed on Dec. 23, 2021.

(51) Int. Cl. C08L 95/00; C08K 3/32; C08K 11/00

(52) U.S. Cl. CPC C08L 95/00; C08K 3/32; C08K 11/00; C08K 2003/329; C08L 2205/025; C08L 2205/03; C08L 2207/066; C08L 2207/20

(57) ABSTRACT

The present disclosure provides embodiments of an asphalt composition and methods of making that may include asphalt, supplemental asphaltene, and epoxy-functionalized polyethylene.

### CROSS-REFERENCE TO RELATED APPLICATION

This application claims the benefit of and priority to U.S. Application Ser. No. 63/293,126 filed Dec. 23, 2021, and entitled “ASPHALT COMPOSITIONS INCLUDING ASPHALTENE AND EPOXY-FUNCTIONALIZED ETHYLENE COPOLYMER,” the entire contents of which are incorporated by reference in the present disclosure

### TECHNICAL FIELD

Embodiments described herein generally relate to asphalt and specifically relate to asphalt compositions including supplemental asphaltene and an epoxy-functionalized ethylene copolymer.

### BACKGROUND

Asphalt pavements are the most common type of pavements in North America, making them an important infrastructure asset. Asphalt mixtures are composed of asphalt, aggregates, and fillers. In some cases, additives or modifiers are also added to improve the mixture properties. Increasing traffic demand, harsh weather conditions, and the tendency for infrastructure operators to reduce cost of maintenance are the major reasons for asphalt performance improvement strategies. This has motivated the industry modify conventional asphalt compositions to improve their performance and extend their service life. Polymer modifiers are one of the most common materials used for asphalt modification. Besides the benefits achieved with the use of polymer modifiers cost and phase separation are among a few drawbacks associated with the employment of these additives. In recent years, the increase public concerns on sustainability have brought the need to use more sustainable streams into asphalt pavements without negatively affecting the binder performance.

Chemically reactive terpolymers have been successfully used to improve polymer miscibility to reduce polymer phase separation during handling and storage of polymer modified systems as well as improving asphalt binder properties. However, their reactivity is highly related to the amount and type of functional groups present in an asphalt composition. Consequently, there is a need to improve the reactivity of the asphalt composition.

### SUMMARY

Embodiments of the present disclosure meet this need by adding supplemental asphaltenes to increase the reactivity of an asphalt composition to improve the performance of polymer modifier systems. This improved performance may include enhanced rheological and tensile properties of an asphalt composition.

According to at least one embodiment of the present disclosure, An asphalt composition comprising: at least 70 wt. %, based on the total weight of the asphalt composition, of asphalt; from 0.25 wt. % to 5 wt. %, based on the total weight of the asphalt composition, of an epoxy-functionalized ethylene copolymer represented by the empirical formula “E/X/Y/Z”, wherein E represents copolymerized repeat units of the formula —(CH2CH2)—derived from ethylene; X represents copolymerized repeat units of the formula —(CH2CR1R2), wherein R1 is hydrogen, methyl, or ethyl, and R2 is carboalkoxy, acyloxy, or alkoxy of 1 to 10 carbon atoms; Y represents copolymerized repeat units of the formula —(CH2CR3R4), wherein R3 is hydrogen or methyl and R4 is carboglycidoxy or glycidoxy; and Z represents optional copolymerized repeat units derived from one or more additional comonomers; wherein the amount of X is from 0.1 to about 40 wt. %, the amount of Y is from about 0.3 to about 15 wt. %, the amount of Z is from 0 to about 10 wt. %, the amount of E is complementary to the amounts of X, Y and Z, and wherein the weight percentages of E, X, Y and Z are based on the total weight of the epoxy-functionalized ethylene copolymer; and from 0.5 wt. % to 10 wt. %, based on the total weight of the asphalt composition, of supplemental asphaltene. The asphalt composition exhibits the following properties as determined via Multiple Stress Creep Recovery (MSCR) testing: Non-recoverable creep compliance (Jnr) @ 3.2 kPa<0.2, and Percent Recovery (% R) @ 3.2 kPa>40%.

These and other embodiments are described in more detail in the following detailed description.

### DETAILED DESCRIPTION

Specific embodiments of the present application will now be described. These embodiments are provided so that this disclosure will be thorough and complete and will fully convey the scope of the subject matter to those skilled in the art.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LLDPE,” includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. Nos. 3,914,342 and 5,854,045). The LLDPE resins can be made via gas-phase, solution-phase, or slurry polymerization or any combination thereof, using any type of reactor or reactor configuration known in the art.

As used herein, the term “asphalt” is a complex mixture that may be separated into two major fractions of hydrocarbons, asphaltenes and maltenes. The asphaltenes may be polycyclic aromatics and may contain polycyclic aromatics that mostly have polar functionality. One or more of the following functionalities may be present: carboxylic acids, amines, sulfides, sulfoxides, sulfones, sulfonic acids, porphyrins, porphyrin derivatives, metalloporphyrins or metalloporphyrin derivatives comprising cations of vanadium, nickel or iron. The maltene phase may contain polar aromatics, aromatics, and naphthene. Without being bound by theory, it is generally believed that asphalt may be a colloidal dispersion with the asphaltenes dispersed in the maltenes and the polar aromatics may function as dispersing agents. The asphaltenes may be relatively high in molecular weight (about 1500 daltons) as compared with the other components of asphalt. The asphaltenes may be amphoteric in nature and form aggregates through self-association that offer some viscoelastic behavior to asphalt. Asphaltenes may vary in amount and functionality depending on the crude source from which the asphalt is derived. Specific examples of suitable crude asphalts may include Ajax, Marathon, Wyoming Sour, Mayan, Venezuelan, Canadian, Arabian, Trinidad Lake, Salamanca, Brazilian, Argentinean, Uruguayan, Chilean and combinations of two or more thereof. The term “asphalt” may include an “asphalt,” which includes one or more of bitumen, asphaltenes; heterocyclic compounds containing sulphur, nitrogen, and oxygen; and trace amounts of metals such as iron, nickel, and vanadium. The term “asphalt” may further include aggregates. Aggregates may include stone, sand, gravel, and combinations thereof.

As used herein, the “asphalt composition” means the mixture of asphalt, asphaltene and an epoxy-functionalized ethylene copolymer, and optionally other ingredients.

As used herein, “supplemental asphaltene” means the asphaltene added separately from the asphalt mixture described above.

The terms “pre-consumer recycled polymer” and “post-industrial recycled polymer” refer to polymers, including blends of polymers, recovered from pre-consumer material, as defined by ISO-14021. The generic term pre-consumer recycled polymer thus includes blends of polymers recovered from materials diverted from the waste stream during a manufacturing process. The generic term pre-consumer recycled polymer excludes the reutilization of materials, such as rework, regrind, or scrap, generated in a process and capable of being reclaimed within the same process that generated it.

The term “post consumer recycle” resin (or “PCR”), as used herein, refers to a polymeric material that includes materials previously used in a consumer or industry application i.e., pre-consumer recycled polymer and post-industrial recycled polymer. PCR is typically collected from recycling programs and recycling plants. The PCR may include one or more of a polyethylene, a polypropylene, a polyester, a polystyrene, an acrylonitrile butadiene styrene, a polyamide, an ethylene vinyl alcohol, or an ethylene vinyl acetate. The PCR may include one or more contaminants. The contaminants may be the result of the polymeric material's use prior to being repurposed for reuse. For example, contaminants may include paper, ink, food residue, or other recycled materials in addition to the polymer, which may result from the recycling process. PCR is distinct from virgin polymeric material. A virgin polymeric material (such as a virgin bimodal polyethylene resin) does not include materials previously used in a consumer or industry application. Virgin polymeric material has not undergone, or otherwise has not been subject to, a heat process or a molding process, after the initial polymer manufacturing process. The physical, chemical, and flow properties of PCR resins differ when compared to virgin polymeric resin, which in turn can present challenges to incorporating PCR into formulations for commercial use.

Reference will now be made in detail to embodiments of asphalt compositions as described herein. Embodiments of the asphalt compositions may include asphalt; supplemental asphaltene; and an epoxy-functionalized ethylene copolymer.

### Asphalt

In embodiments, the asphalt composition described herein may include asphalt. In some embodiments, the asphalt may include a petroleum derivative. The asphalt may include bitumen. Bitumen may be saturated and unsaturated hydrocarbons (e.g., aliphatic and aromatic hydrocarbons). In addition, the asphalt may include one or more asphaltenes; heterocyclic compounds containing sulphur, nitrogen, and oxygen; and trace amounts of metals such as iron, nickel, and vanadium. In some embodiments, the asphalt may be commercially-available. In some embodiments, the asphalt may be naturally-occurring. In some embodiments, the asphalt may include from about 70 weight percent (wt. %) to 100 wt. % of bitumen, based on the total weight of the asphalt. In other embodiments, the asphalt may be at least 90% of bitumen. In other embodiments, the asphalt may include up to 100 wt. % of bitumen. In one embodiment, the asphalt composition is free of rubber.

As will be described below, the asphalt may include some intrinsic asphaltene separate from the added supplemental asphaltene. In one or more embodiments, the asphalt may include 5 to 35 wt % intrinsic asphaltene, from 15 to 35 wt %, from 20 to 35 wt %, from 25 to 35 wt %, or from 25 to 30 wt % intrinsic asphaltene.

In embodiments, the asphalt composition may include at least about from about 70 weight percent (wt. %) to about 99.5 wt. % asphalt, based on the total weight of the asphalt composition. In some embodiments, the asphalt composition may include from about 75 wt. % to about 99.5 wt. %, from about 80 wt. % to about 99.5 wt. %, from about 80 wt. % to about 95 wt. %, from about 80 wt. % to about 90 wt. %, from about 80 wt. % to about 85 wt. %, from about 85 wt. % to about 99.5 wt. %, from about 85 wt. % to about 95 wt. %, from about 85 wt. % to about 90 wt. %, from about 90 wt. % to about 99.5 wt. %, from about 90 wt. % to about 95 wt. %, or from about 95 wt. % to about 99.5 wt. % asphalt, based on the total weight of the asphalt composition.

### Epoxy-Functionalized Ethylene Copolymer

In embodiments, the asphalt composition may include an epoxy-functionalized ethylene copolymer. The epoxy-functionalized ethylene copolymer may be represented by the formula E/X/Y/Z, which includes copolymer units E, X, Y, and Z.

In embodiments, E may be a copolymer unit —(CH2CH2)— derived from ethylene.

In embodiments, X may represent copolymerized repeat units of the formula —(CH2CR1R2), wherein R1 is hydrogen, methyl, or ethyl, and R2 is carboalkoxy, acyloxy, or alkoxy of 1 to 10 carbon atoms;

In further embodiments, the epoxy-functionalized ethylene copolymer may include from about 0.1 wt. % to about 40 wt. % X, from about 0.1 wt. % to about 30 wt. % X, from about 0.1 wt. % to about 20 wt. % X, from about 0.1 wt. % to about 10 wt. % X, from about 10 wt. % to about 40 wt. % X, from about 10 wt. % to about 30 wt. % X, from about 10 wt. % to about 20 wt. % X, from about 20 wt. % to about 40 wt. % X, from about 20 wt. % to about 30 wt. % X, or from about 30 wt. % to about 40 wt. % X, based on the total weight of the epoxy-functionalized ethylene copolymer.

In embodiments, Y may be a copolymer unit —(CH₂CR³R⁴)—. In some embodiments, R³ may be hydrogen or methyl. In some embodiments, R⁴ may be carboglycidoxy or glycidoxy. In some embodiments, Y may be selected from the group consisting of glycidyl acrylate, glycidyl methacrylate, glycidyl butyl acrylate, glycidyl vinyl ether, and combinations of two or more of glycidyl acrylate, glycidyl methacrylate, glycidyl butyl acrylate, and glycidyl vinyl ether. In further embodiments, the epoxy-functionalized ethylene copolymer may include from about 0.3 wt. % to about 15 wt. % Y, from about 0.3 wt. % to about 10 wt. % Y, from about 0.3 wt. % to about 5 wt. % Y, from about 1 wt. % to about 10 wt. % Y, from about 1 wt. % to about 5 wt. % Y, from about 5 wt. % to about 15 wt. % Y, from about 5 wt. % to about 10 wt. % Y, or from about 10 wt. % to about 15 wt. % Y, based on the total weight of the epoxy-functionalized ethylene copolymer.

In embodiments, Z may be a copolymer derived from additional comonomers including carbon monoxide, sulfur dioxide, acrylonitrile, or other monomers. In further embodiments, the epoxy-functionalized ethylene copolymer may optionally include from about 0 wt. % to about 10 wt. % Z, from about 0 wt. % to about 8 wt. % Z, from about 0 wt. % to about 6 wt. % Z, from about 0 wt. % to about 4 wt. % Z, from about 0 wt. % to about 2 wt. % Z, from about 2 wt. % to about 10 wt. % Z, from about 2 wt. % to about 8 wt. % Z, from about 2 wt. % to about 6 wt. % Z, from about 2 wt. % to about 4 wt. % Z, from about 4 wt. % to about 10 wt. % Z, from about 4 wt. % to about 8 wt. % Z, from about 4 wt. % to about 6 wt. % Z, from about 6 wt. % to about 10 wt. % Z, from about 6 wt. % to about 8 wt. % Z, or from about 8 wt. % to about 10 wt. % Z, based on the total weight of the epoxy-functionalized ethylene copolymer.

In embodiments, the epoxy-functionalized ethylene copolymer may include an ethylene vinyl acetate glycidyl methacrylate terpolymer, an ethylene n-butyl acrylate glycidyl methacrylate terpolymer or an ethylene methyl acrylate glycidyl methacrylate terpolymer.

In embodiments, the asphalt composition may include from about 0.1 weight percent (wt. %) to about 10 wt. % epoxy-functionalized ethylene copolymer, based on the total weight of the asphalt composition. In some embodiments, the asphalt composition may include from about 0.1 wt. % to about 5 wt. %, from about 0.1 wt. % to about 1 wt. %, from about 0.1 wt. % to about 0.5 wt. %, from about 0.25 wt. % to about 5 wt. %, from about 0.25 wt. % to about 1 wt. %, from about 0.5 wt. % to about 5 wt. %, from about 0.5 wt. % to about 2 wt. %, from about 1 wt. % to about 5 wt. %, or from about 1 wt. % to about 5 wt. %, based on the total weight of the asphalt composition.

In some embodiments, the epoxy-functionalized ethylene copolymer may have a melt flow index as determined by ASTM D1238-65T, Condition E, of about 1000 g/10 min or less, from about 0.3 g/10 min to about 1000 g/10 min, from about 0.3 g/10 min to about 500 g/10 min, from about 0.3 g/10 min to about 250 g/10 min, or from about 0.3 g/10 min to about 100 grams/10 minutes.

### Supplemental Asphaltene

The asphalt composition may include from 0.5 wt. % to 10 wt. %, based on the total weight of the asphalt composition, of supplemental asphaltene. In further embodiments, the asphalt composition comprises from 2 to 8 wt. % supplemental asphaltene, or from 4 to 8 wt. % supplemental asphaltene.

In further embodiments, the asphalt composition may comprise a total asphaltene content greater than 10 wt. %, greater than 15 wt. %, greater than 20 wt. %, greater than 25 wt. %, greater than 30 wt. %, or greater than 35 wt. % wherein the total asphaltene content equals the supplemental asphaltene plus intrinsic asphaltene content in the asphalt.

### PCR

In embodiments, the asphalt composition may include PCR. In embodiments, the PCR may include one or more of an ethylene-based polymer, a propylene-based polymer, a polyester, a polystyrene, an acrylonitrile butadiene styrene, a polyamide, an ethylene vinyl alcohol, an ethylene vinyl acetate, and/or ethylene or propylene functionalized copolymers, with Maleic Anhydride, Methacrylic acid and Acrylic acid, as: FUSABOND™, AMPLIFY™, BYNEL™, SURLYN™, NUCREL™ (used as tie layer on multilayer structure). In embodiments, the PCR may include up to 99.99 wt. % of one or more of an ethylene-based polymer, a propylene-based polymer, a polyester, a polystyrene, an acrylonitrile butadiene styrene, a polyamide, an ethylene vinyl alcohol, or an ethylene vinyl acetate, based on the total weight of the PCR. In other embodiments, the PCR may include from about 51 wt. % to about 99.99 wt. %, from about 60 wt. % to about 99.99 wt. %, from about 70 wt. % to about 99.99 wt. %, from about 80 wt. % to about 99.99 wt. %, or from about 90 wt. % to about 99.99 wt. % of one or more of an ethylene-based polymer, a propylene-based polymer, a polyester, a polystyrene, an acrylonitrile butadiene styrene, a polyamide, an ethylene vinyl alcohol, an ethylene vinyl acetate, based on the total weight of the PCR. In further embodiments, the PCR may include an ethylene-based polymer.

In embodiments, the PCR may include at least 0.01 wt. % contaminants based on the total weight of the PCR. In other embodiments, the PCR may include at least from about 0.01 wt. % to about 1 wt. %, from about 0.01 wt. % to about 5 wt. %, from about 0.01 wt. % to about 10 wt. %, from about 0.01 wt. % to about 20 wt. %, from about 0.01 wt. % to about 30 wt. %, or from about 0.01 wt. % to about 40 wt. % contaminants based on the total weight of the PCR.

Incorporating a PCR into the asphalt composition may provide an asphalt composition with sustainability benefits. In further embodiments, while providing sustainability benefits, the presently-described asphalt compositions may be resistant to failure modes such as rutting and cracking at various temperature regimes. Additionally, while having improved or comparable properties, when compared to asphalt compositions with a polymer component that has not been recycled, the asphalt compositions described herein may further have increased sustainability benefits. In some embodiments, the PCR may include an HDPE. The HDPE PCR may include a density from about 0.945 grams per cubic centimeter (g/cc) to about 0.970 g/cc, from about 0.950 g/cc to about 0.965 g/cc, from about 0.955 g/cc to about 0.965 g/cc.

In some embodiments, the PCR may include an LLDPE. The LLDPE PCR may include a density from about 0.858 grams per cubic centimeter (g/cc) to about 0.918 g/cc, from about 0.858 g/cc to about 0.910 g/cc, from about 0.858 g/cc to about 0.900 g/cc, from about 0.858 g/cc to about 0.890 g/cc, from about 0.858 g/cc to about 0.880 g/cc, from about 0.858 g/cc to about 0.870 g/cc, from about 0.870 grams per cubic centimeter (g/cc) to about 0.918 g/cc, from about 0.870 g/cc to about 0.910 g/cc, from about 0.870 g/cc to about 0.900 g/cc, from about 0.870 g/cc to about 0.890 g/cc, from about 0.870 g/cc to about 0.880 g/cc, from about 0.880 grams per cubic centimeter (g/cc) to about 0.918 g/cc, from about 0.880 g/cc to about 0.910 g/cc, from about 0.880 g/cc to about 0.900 g/cc, from about 0.880 g/cc to about 0.890 g/cc, from about 0.890 grams per cubic centimeter (g/cc) to about 0.918 g/cc, from about 0.890 g/cc to about 0.910 g/cc, from about 0.890 g/cc to about 0.900 g/cc, from about 0.900 grams per cubic centimeter (g/cc) to about 0.918 g/cc, from about 0.900 g/cc to about 0.910 g/cc, or from about 0.910 grams per cubic centimeter (g/cc) to about 0.918 g/cc.

In some embodiments, the LLDPE PCR may include a melt index, 12, of less than about 20 grams per ten minutes (g/10 min) when measured according to ASTM D1238 at 190° C. and 2.16 kg load. In further embodiments, the LLDPE may have a melt index, I₂, from about 0.1 g/10 min to about 20.0 g/10 min, from about 0.1 g/10 min to about 15.0 g/10 min, from about 0.1 g/10 min to about 10.0 g/10 min, from about 0.1 g/10 min to about 5 g/10 min, from about 0.1 g/10 min to about 1.0 g/10 min, from about 0.1 g/10 min to about 0.5 g/10 min, from about 1.0 g/10 min to about 20.0 g/10 min, from about 1.0 g/10 min to about 15.0 g/10 min, from about 1.0 g/10 min to about 10.0 g/10 min, from about 1.0 g/10 min to about 5 g/10 min, from about 5.0 g/10 min to about 20.0 g/10 min, from about 5.0 g/10 min to about 15.0 g/10 min, from about 5.0 g/10 min to about 10.0 g/10 min, from about 10.0 g/10 min to about 20.0 g/10 min, from about 10.0 g/10 min to about 15.0 g/10 min, or from about 15.0 g/10 min to about 20.0 g/10 min.

In embodiments, the asphalt composition may include from about 0.25 weight percent (wt. %) to about 20 wt. % PCR, based on the total weight of the asphalt composition. In some embodiments, the asphalt composition may include from about 0.25 wt. % to about 20 wt. %, from about 0.25 wt. % to about 15 wt. %, from about 0.25 wt. % to about 10 wt. %, from about 0.25 wt. % to about 5 wt. %, from about 0.25 wt. % to about 1 wt. %, from about 1 wt. % to about 20 wt. %, from about 1 wt. % to about 15 wt. %, from about 1 wt. % to about 10 wt. %, from about 1 wt. % to about 5 wt. %, from about 5 wt. % to about 20 wt. %, from about 5 wt. % to about 15 wt. %, from about 5 wt. % to about 10 wt. %, from about 10 wt. % to about 20 wt. %, from about 10 wt. % to about 15 wt. %, or from about 15 wt. % to about 20 wt. % PCR, based on the total weight of the asphalt composition.

Without being bound by theory, it is believed that the functionalization of polymers may be an effective route of chemically binding a material to enhance the rheological and tensile properties of an asphalt composition. Further without being bound by theory, it is believed the epoxy-functionalized ethylene copolymer may be relatively more compatible with ethylene-based polymers as compared to other polymers.

The asphalt composition may optionally further comprise one or more polymers in addition to the PCR, referred to herein as “additional polymers.” The one or more additional polymers may not react with asphalt or with the epoxy-functionalized ethylene copolymers described herein. Because the one or more additional polymers may not react with the asphalt or with the epoxy-functionalized ethylene copolymers, they may be referred to as “diluent” polymers.

### Additives

In embodiments, the asphalt composition may include one or more additives. The one or more additives may allow the asphalt composition to have improved stability and may influence the rheological properties of the asphalt composition. In some embodiments, the one or more additives may allow for the asphalt composition to include crosslinking with sulfur. In further embodiments, the one or more additives may include sulfur-based additives. Commercially-available sulfur-based additives may include BGA from Ergon, Inc., which includes hydrotreated naphthenic petroleum oil, elemental sulfur, a rheological additive, and other components.

In embodiments, the asphalt composition may include an acid. In some embodiments, the acid may be polyphosphoric acid. In further embodiments, the polymer-enhanced asphalt composition may include from about 0.05 wt. % to about 1 wt. %, from about from about 0.05 wt. % to about 0.8 wt. %, from about 0.05 wt. % to about 0.6 wt. %, from about 0.05 wt. % to about 0.4 wt. %, from about 0.05 wt. % to about 0.2 wt. %, from about 0.2 wt. % to about 1 wt. %, from about from about 0.2 wt. % to about 0.8 wt. %, from about 0.2 wt. % to about 0.6 wt. %, from about 0.2 wt. % to about 0.4 wt. %, from about 0.4 wt. % to about 1 wt. %, from about from about 0.4 wt. % to about 0.8 wt. %, from about 0.4 wt. % to about 0.6 wt. %, from about 0.6 wt. % to about 1 wt. %, from about from about 0.6 wt. % to about 0.8 wt. %, or from about 0.8 wt. % to about 1 wt. % acid, based on the total weight of the asphalt composition.

In embodiments, the asphalt composition may include an anhydride. In further embodiments, the asphalt composition may include from about 0.05 wt. % to about 1 wt. %, from about from about 0.05 wt. % to about 0.8 wt. %, from about 0.05 wt. % to about 0.6 wt. %, from about 0.05 wt. % to about 0.4 wt. %, from about 0.05 wt. % to about 0.2 wt. %, from about 0.2 wt. % to about 1 wt. %, from about from about 0.2 wt. % to about 0.8 wt. %, from about 0.2 wt. % to about 0.6 wt. %, from about 0.2 wt. % to about 0.4 wt. %, from about 0.4 wt. % to about 1 wt. %, from about from about 0.4 wt. % to about 0.8 wt. %, from about 0.4 wt. % to about 0.6 wt. %, from about 0.6 wt. % to about 1 wt. %, from about from about 0.6 wt. % to about 0.8 wt. %, or from about 0.8 wt. % to about 1 wt. % anhydride, based on the total weight of the asphalt composition.

### Asphalt Composition Properties

The asphalt composition may exhibit the following properties as determined via Multiple Stress Creep Recovery (MSCR) testing: a non-recoverable creep compliance (Jnr) @ 3.2 kPa <0.2, and Percent Recovery (% R) @ 3.2 kPa>40%. In further embodiments, the Jnr of the asphalt composition less than 0.10, or less than 0.05. The % R of the asphalt composition is greater than 60%, greater than 70%, or greater than 75%. The percent recovery value from the MSCR test is believed to be a measure of the elastic response of the sample. The non-recoverable creep compliance is believed to be an indicator of resistance of the asphalt to permanent deformation after repeated exposure to a load of known stress.

### Method of Making

To produce the asphalt composition, asphalt may be blended with the supplemental asphaltene, the epoxy-functionalized ethylene copolymer, and optionally polyphosphoric acid and PCR. In some embodiments, the asphalt composition may be heated during blending. In some embodiments, the asphalt compositions may be heated to up to 200° C. In other embodiments, the asphalt composition may be heated to a temperature from about 100° C. to about 200° C., from about 100° C. to about 180° C., from about 100° C. to about 160° C., from about 100° C. to about 140° C., from about 100° C. to about 120° C., from about 120° C. to about 200° C., from about 120° C. to about 180° C., from about 120° C. to about 160° C., from about 120° C. to about 140° C., from about 140° C. to about 200° C., from about 140° C. to about 180° C., from about 140° C. to about 160° C., from about 160° C. to about 200° C., from about 160° C. to about 180° C., or from about 180° C. to about 200° C.

In some embodiments, to produce the asphalt composition, the blending may occur for about 0.5 hours to about 4 hours, from about 0.5 hours to about 3 hours, from about 0.5 hours to about 2 hours, from about 0.5 hours to about 1 hour, from about 1 hour to about 5 hours, from about 1 hour to about 4 hours, from about 1 hour to about 3 hours, from about 1 hour to about 2 hours, from about 2 hours to about 5 hours, from about 2 hours to about 4 hours, from about 2 hours to about 3 hours, from about 3 hours to about 5 hours, from about 3 hours to about 4 hours, or from about 4 hours to about 5 hours.

### Test Methods

Density was measured according to ASTM D792-13, Standard Test Methods for Density and Specific Gravity (Relative Density) of Plastics by Displacement, Method B (for testing solid plastics in liquids other than water, e.g., in liquid 2-propanol). Results were reported in units of grams per cubic centimeter (g/cm3).

Melt Index (190° C., 2.16 kg, “12”) Test Method: ASTM D 1238-13, Standard Test Method for Melt Flow Rates of Thermoplastics by Extrusion Plastometer, using conditions of 190° C./2.16 kilograms (kg). Results were reported in units of grams eluted per 10 minutes (g/10 min.) or the equivalent in decigrams per 1.0 minute (dg/1 min.).

The American Association of State Highway and Transportation Officials (AASHTO) is a standard setting body that publishes specifications, test protocols and guidelines for asphalt compositions, which may be used in highway design and construction. The test methods as used herein include the following:

### Multiple Stress Creep and Recovery

Rolling Thin-Film Oven aged samples were studied using Multiple Stress Creep and Recovery (MSCR) at 67° C. in accordance with AASHTO T350-14 “Standard Method of Test for Multiple Stress Creep Recovery (MSCR) Test of Asphalt Using a Dynamic Shear Rheometer (DSR)”. The percent recovery value from the MSCR test is believed to be a measure of the elastic response of the sample. The non-recoverable creep compliance is believed to be an indicator of resistance of the asphalt to permanent deformation after repeated exposure to a load of known stress.

### Saturate, Aromatic, Resin and Asphaltene (SARA) Fractions Analysis

Fractions were generated using the following procedure (similar to ASTM D2007-93): 1 g of sample was dissolved in 50 mL of n-heptane. The mixture was sonicated and stored in the dark for overnight. The n-heptane insoluble matter (asphaltene fraction) was filtered using Whatman 934 AH 47 mm filter paper with a Buchner funnel and vacuum filtration flask. The n-heptane insoluble matter on the filter paper was rinsed with n-heptane and then dried at room temperature under a house nitrogen stream. The maltenes, which are n-heptane soluble, were obtained by drying the n-heptane solution under a nitrogen stream. The dried maltenes were redissolved in 6 mL of n-heptane. The maltenes solution was mixed with 3 g of activated alumina, in which maltenes were adsorbed onto the surface of activated alumina. The maltenes-alumina slurry was dried while being continuously stirred under a stream of nitrogen. A glass column was packed with 40 g of neutral alumina adsorbent (activated at 450° C. for 6 h, 1 wt % water added). The maltene-adsorbed alumina was packed on the top of the neutral alumina adsorbent in the glass column. Then a ½″ layer of glass beads was added, with a glass wool plug at the top. The glass beds and glass wool served to keep the maltene adsorbed alumina layer in place as the elution solvents were added. Saturates were obtained by eluting the packed column with 80 mL of n-heptane. This was followed by 80 mL of toluene to elute the aromatics. A total of 40 mL of a 50:50 (v/v) toluene/ethanol mixture, 40 mL of toluene, and 40 mL of ethanol were added sequentially to elute the resins. Each fraction was collected into a tared bottle. The solvent in each effluent was dried under a stream of house nitrogen and the dry weight recorded. The percent of each fraction was calculated by dividing the weight of each fraction by the sum of the weights of the fractions. The commercials glass column was the following: 26 mm i.d. 305 mm length, Synthware C383230C, Fisher catalog #31-500-960. The commercial alumina adsorbent was the following: 80-200 mesh, Fisher catalog #A540-500.

### EXAMPLES

The following examples illustrate features of the present disclosure but are not intended to limit the scope of the disclosure. The following experiments analyzed the performance of embodiments of asphalt compositions described herein.

The asphalt binder used in the examples had a PG grading of 64-22, and included 26 wt % saturates; 34.9% wt % aromatics, 10.2 wt % resins and 28.9 wt. % asphaltenes as measured according to SARA Fractions Analysis.

The epoxy-functionalized polyethylene copolymers utilized in the Examples are provided in Table 1. The epoxy-functionalized polyethylene copolymers E/X/Y/Z-1-E/X/Y/Z-4 listed in Table 1 were prepared by standard free-radical copolymerization methods, using high pressure, operating in a continuous manner. Monomers are fed into the reaction mixture in a proportion, which relates to the monomer's reactivity, and the amount desired to be incorporated. In this way, uniform, near-random distribution of monomer units along the chain is achieved. Polymerization in this manner is well known, and is described in U.S. Pat. No. 4,351,931 (Armitage), which is hereby incorporated by reference. Other polymerization techniques are described in U.S. Pat. No. 5,028,674 (Hatch et al.) and U.S. Pat. No. 5,057,593 (Statz), both of which are also hereby incorporated by reference.

TABLE 1

| Epoxy- | | | | | |
|---|---|---|---|---|---|
| functionalized | | | | | MI, |
| polyethylene | Ethylene | nBA | VA | GMA | g/10 |
| copolymer | (wt %) | (wt %) | (wt %) | (wt %) | min |
| E/X/Y/Z-1 | 70 | 21 | 0 | 9 | 75 |
| E/X/Y/Z-2 | 59.75-61.75 | 33-35 | 0 | 5.25 | 20 |
| E/X/Y/Z-3 | 70 | 21 | 0 | 9 | 8 |
| E/X/Y/Z-4 | 76 | 0 | 15 | 9 | 8 |

The components of the experimental asphalt compositions are provided in Table 3 below. The components were mixed by a mechanical mixer using a stepwise mixing process listed in the following Table 2.

TABLE 2

| | | | Mixing | Mixing |
|---|---|---|---|---|
| | | Temperature, | Time, | shear, |
| Component | Steps | C. | min | rpm |
| Asphalt binder | 1 | 165 | 30 | 300 |
| Asphaltene | 2 | 165 and 185 | 30 | 300 to 800 |
| PCR | 3 | 165 | 60 | 300-4000 |
| Epoxy-functionalized | 4 | 165 | 120 | 300 |
| polyethylene copolymer | | | | |
| PPA | 5 | 165 | 60 | 300 |

As shown in Table 3 below, the inventive examples demonstrate a greatly improved balance of Non-recoverable creep compliance (Jnr) and Percent Recovery (% R). Specifically, all of the inventive examples demonstrate a Jnr value less than 0.2, and a % R value >40%.

TABLE 3

| | | Epoxy- | | | Non- | |
|---|---|---|---|---|---|---|
| | | functionalized | | | recoverable | |
| | Asphalt | polyethylene | Supplemental | | creep | % |
| Asphalt | Binder | copolymer (wt | Asphaltene, | PPA, | compliance, | Recovery, |
| Composition | (wt %) | % | (wt %) | (wt %) | 3.2 Kpa (JnR) | 3.2 kPa |
| Comparative | 100 | — | 0 | — | 2.26 | 0.3 |
| Example 1 | | | | | | |
| Comparative | 98 | — | 2 | — | 0.95 | 6.0 |
| Example 2 | | | | | | |
| Comparative | 96 | — | 4 | — | 0.60 | 9.3 |
| Example 3 | | | | | | |
| Comparative | 92 | — | 8 | — | 0.17 | 27.0 |
| Example 4 | | | | | | |
| Comparative | 98.05 | 1.75 wt % | 0 | 0.2 | 0.40 | 50.8 |
| Example 5 | | E/X/Y/Z-2 | | | | |
| Inventive | 96.05 | 1.75 wt % | 2 | 0.2 | 0.16 | 62.4 |
| Example 1 | | E/X/Y/Z-2 | | | | |
| Inventive | 94.05 | 1.75 wt % | 4 | 0.2 | 0.13 | 61.9 |
| Example 2 | | E/X/Y/Z-2 | | | | |
| Inventive | 90.05 | 1.75 wt % | 8 | 0.2 | 0.04 | 72.0 |
| Example 3 | | E/X/Y/Z-2 | | | | |
| Inventive | 90.3 | 1.50 wt % | 8 | 0.2 | 0.05 | 80.4 |
| Example 4 | | E/X/Y/Z-4 | | | | |
| Inventive | 90.3 | 1.50 wt % | 8 | 0.2 | 0.05 | 78.0 |
| Example 5 | | E/X/Y/Z-3 | | | | |
| Inventive | 90.3 | 1.50 wt % | 8 | 0.2 | 0.08 | 71.1 |
| Example 6 | | E/X/Y/Z-1 | | | | |
| Inventive | 90.55 | 1.25 wt % | 8 | 0.2 | 0.13 | 57.1 |
| Example 7 | | E/X/Y/Z-2 | | | | |
| Inventive | 91.05 | 0.75 wt % | 8 | 0.2 | 0.19 | 43.1 |
| Example 8 | | E/X/Y/Z-2 | | | | |
| Inventive | 90.55 | 1.25 wt % | 8 | 0.2 | 0.07 | 72.9 |
| Example 9 | | E/X/Y/Z-3 | | | | |
| Inventive | 91.05 | 0.75 wt % | 8 | 0.2 | 0.12 | 56.8 |
| Example 10 | | E/X/Y/Z-3 | | | | |
| Inventive | 91.3 | 0.5 wt % | 8 | 0.2 | 0.19 | 45.0 |
| Example 11 | | E/X/Y/Z-3 | | | | |

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A method of making an asphalt composition wherein the asphalt composition exhibits the following properties as determined via Multiple Stress Creep Recovery (MSCR) testing:
Non-recoverable creep compliance (Jnr) @ 3.2 kPa<0.2, and
Percent Recovery (% R) @ 3.2 kPa>40%
comprising mixing
at least 70 wt. %, based on the total weight of the asphalt composition, of asphalt:
from 0.25 wt. % to 5 wt. %, based on the total weight of the asphalt composition, of an epoxy-functionalized ethylene copolymer represented by the empirical formula “E/X/Y/Z”, wherein
E represents copolymerized repeat units of the formula —(CH2CH2)— derived from ethylene;
X represents copolymerized repeat units of the formula —(CH2CR1R2), wherein R¹ is hydrogen, methyl, or ethyl, and R2 is carboalkoxy, acyloxy, or alkoxy of 1 to 10 carbon atoms;
Y represents copolymerized repeat units of the formula —(CH2CR3R4), wherein R³ is hydrogen or methyl and R4 is carboglycidoxy or glycidoxy; and
Z represents optional copolymerized repeat units derived from one or more additional comonomers;
wherein the amount of X is from 0.1 to about 40 wt. %, the amount of Y is from about 0.3 to about 15 wt. %, the amount of Z is from 0 to about 10 wt. %, the amount of E is complementary to the amounts of X, Y and Z, and wherein the weight percentages of E, X, Y and Z are based on the total weight of the epoxy-functionalized ethylene copolymer;
from 0.5 wt. % to 10 wt. %, based on the total weight of the asphalt composition, of supplemental asphaltene.

2. The method of claim 1, wherein the asphalt composition comprises from 2 to 8 wt. % supplemental asphaltene.

3. The method of claim 1, wherein the asphalt composition comprises from 0.5% to 2% of the epoxy-functionalized ethylene copolymer.

4. The method of claim 1, wherein the % R of the asphalt composition >60%, or preferably >70%, or more preferably >75%.

5. The method of claim 1, wherein the Jnr of the asphalt composition <0.10, or preferably <0.05.

6. The method of claim 1, wherein the asphalt composition comprises a total asphaltene content >10 wt. %, or >15 wt. %, or >20 wt. %, or >25 wt. %, or >30 wt. %, wherein the total asphaltene content equals the supplemental asphaltene plus intrinsic asphaltene content in the asphalt.

7. The method of claim 1, wherein the asphalt composition is free of rubber.

8. The method of claim 1, wherein the asphalt composition comprises post-consumer recycled resin (PCR), wherein the PCR comprises a blend of polyethylene recovered from post-consumer material.

9. The method of claim 8, wherein the PCR comprises linear low density polyethylene (LLDPE).

10. The method of claim 8, wherein the asphalt composition comprises 0.01 to 10 wt % PCR.

11. The method of claim 1, wherein the asphalt composition comprises polyphosphoric acid.

12. The method of claim 11, wherein the asphalt composition comprises 0.01 to 1.0 wt % polyphosphoric acid.

13. (canceled)

14. The method of claim 1, further comprising adding polyphosphoric acid to the mixture of the asphalt, the epoxy-functionalized ethylene copolymer, and the supplemental asphaltene.

15. The method of claim 13, further comprising adding post-consumer recycled resin (PCR) to the mixture of the asphalt, the epoxy-functionalized ethylene copolymer, the supplemental asphaltene, and the polyphosphoric acid, wherein the PCR comprises a blend of polyethylene recovered from post-consumer material.

16. The method of claim 9, wherein the asphalt composition comprises 0.01 to 10 wt % PCR.
